(19) United States
(12) Patent Application Publication
(10) Pub. No.: US 2011/0095581 A1
(43) Pub. Date: Apr. 28, 2011

(54) PORTABLE SEAT CUSHION

(76) Inventor: Wendell Craig Pierce, Chatsworth, GA (US)

(21) Appl. No.: 12/912,201

(22) Filed: Oct. 26, 2010

Related U.S. Application Data
(60) Provisional application No. 61/279,763, filed on Oct. 26, 2009.

(51) Int. Cl. A47C 7/62; B29C 35/02; B29C 71/00; B29C 37/00; B29C 45/72

(52) U.S. Cl. 297/219.1; 264/319; 264/129; 264/154; 264/328.14

(57) ABSTRACT

A portable seat cushion for easy attachment to and removal from a bench. The seat cushion is preferably made as one piece of flexible polymeric material wherein various components exhibit properties of flexibility and resilience/bias to the overall original shape of the seat cushion.

### CROSS-REFERENCE(S) TO RELATED APPLICATION(S)

This application claims priority to U.S. Provisional Patent Application having Ser. No. 61/279,763 entitled “Bleacher Seat Cushion” which was filed on Oct. 26, 2009, the content of which is incorporated herein by reference in its entirety.

### FIELD

This disclosure relates to the field of portable seats.

### BACKGROUND

Portable seats are useful when attending various types of events including sporting events, athletic competitions, organizational events, spectator events, and any event, meeting, or situation in which it is desirable to have a seat for use in association with a bench. Although portable seats and portable seat cushions often add comfort for a user, such devices often require various parts including metal supports, metal or other hard plastic clips, ties, or other devices in order to maintain a desired position for the seat along a bench. Many portable seats do not even have features to maintain a desired position for the seat along a bench. Those that do are often heavier and/or less comfortable because of the hard parts required to maintain a desired position for the seat along a bench

What is needed, therefore, is an apparatus with many of the desirable features of prior art seats including removable attachment to a bench, but which is softer, lighter, and more comfortable for a user.

### SUMMARY

The above and other needs are met by a portable seat cushion including a seat portion including a first end and a second end; a first extension adjacent the first end of the seat portion, the first extension including a first angled portion extending at an angle ranging from about 105° to about 155° relative to an imaginary plane extending from the first end of the seat portion proximate where the first extension interfaces with the seat portion to the second end of the seat portion proximate where a second extension interfaces with the seat portion; the second extension adjacent the second end of the seat portion including a second angled portion extending at an angle ranging from about 25° to about 75° relative to the imaginary plane, wherein the first angled portion, when moved away from the second extension, is biased toward the second extension to provide a snug fit between the seat cushion and a bench, and wherein the first angled portion is flexible to a degree that the seat cushion can be removably attached to benches that vary in width up to from about 2 inches to about 4 inches. Preferably, the first angled portion extends at an angle ranging from about 120° to about 140° relative to the imaginary plane, and the second angled portion extends at an angle ranging from about 40° to about 60° relative to the imaginary plane.

In one embodiment, the portable seat cushion is manufactured as a single piece of flexible polymeric material wherein the flexible polymeric material includes a mixture including a copolymer thermoplastic; thermoplastic polyalkenes, polyalkene elastomers, or mixtures thereof; and filler material. In certain embodiments, the seat cushion further includes an outer protective polymer layer.

In another embodiment, the portable seat cushion includes an aperture through the seat portion adjacent the first end of the seat portion to form a handle for carrying the portable seat cushion.

In yet another embodiment, the portable seat cushion includes a pressure relief feature along the seat portion adjacent the second end proximate where a user's tailbone typically would be located when sitting on the seat cushion. In specific embodiments, the pressure relief feature includes a cutout portion along the second end of the seat portion, extending along the second extension which provides a void approximately centered along the second end of the seat portion; or an indentation along a top surface of the seat portion approximately centered along the second end of the seat portion.

In other embodiments, the seat portion further includes a cavity portion and non-cavity portion, wherein the cavity portion includes a cavity defined depthwise from the imaginary plane to the non-cavity portion; and a plurality of support pillars extending from the non-cavity portion to the imaginary plane. In certain embodiments, the support pillars are of substantially equal size. In certain embodiments, the support pillars are spaced apart substantially equally in a substantially symmetrical pattern. In some embodiments, at least some of the support pillars include a shape such as, for example, an equilateral polygonal block having a constant cross sectional area, an equilateral polygonal block having a diminishing cross sectional area as the length of the block extends to the imaginary plane from the non-cavity portion, a cone having a diminishing cross-sectional area as the length of the block extends to the imaginary plane from the non-cavity portion, and/or a rounded block having a constant cross sectional area. In some embodiments, at least some of the support pillars include a shape such as, for example, a non-equilateral polygonal block having a constant cross sectional area, and/or a non-equilateral polygonal block having a diminishing cross sectional area as the length of the block extends to the imaginary plane from the non-cavity portion. In some embodiments, at least one of the support pillars includes a cross-section in the shape of a symbolic feature.

In another embodiment, the first extension of the seat portion further includes a first midsection adjacent the first end of the seat portion and situated between the seat portion and the first angled portion; and the second extension further comprises a second midsection adjacent the second end of the seat portion and situated between the seat portion and the second angled portion.

In yet another embodiment, the portable seat cushion includes a pocket located within the seat portion and an access aperture located along an outer surface of the seat portion wherein a heating element can be inserted through the access aperture and into the pocket to warm the portable seat cushion.

In another aspect, embodiments of the disclosure provide a method for manufacturing a portable seat cushion, the method including the steps of (a) adding a polymeric mixture to a mold; and (b) applying heat to the polymeric mixture to cure the mixture in the form of the mold, wherein the cured product comprises a seat portion including a first end and a second end; a first extension adjacent the first end of the seat portion, the first extension including a first angled portion extending at an angle ranging from about 105° to about 155° relative to an imaginary plane extending from the first end of the seat portion proximate where the first extension interfaces with the seat portion to the second end of the seat portion proximate where a second extension interfaces with the seat portion; the second extension adjacent the second end of the seat portion including a second angled portion extending at an angle ranging from about 25° to about 75° relative to the imaginary plane, wherein the first extension is biased toward the second extension to provide a snug fit between the seat cushion and a bench, and wherein the first angled portion, when moved away from the second extension, is biased toward the second extension to provide a snug fit between the seat cushion can be removably attached to benches that vary in width up to from about 2 inches to about 4 inches.

In a related embodiment, step (a) further includes the steps of (a)(i) preheating the polymeric mixture and (a)(ii) injecting the preheated polymer mixture into the mold, or (a)(ii)′ compressing a plurality of mold plates together. In another related embodiment, the method further includes the steps of (c) cutting an aperture through the seat portion to form a carrying handle. In yet another related embodiment, the method further includes the steps of (c)′ adding a pressure relief feature to the seat portion wherein the pressure relief feature includes a cutout portion along the second end of the seat portion, extending along the second extension which provides a void approximately centered along the second end of the seat portion; or an indentation along a top surface of the seat portion approximately centered along the second end of the seat portion; and (d) optionally coating the portable seat cushion with a protective polymer layer.

### BRIEF DESCRIPTION OF THE DRAWINGS

Further features, aspects, and advantages of the present disclosure will become better understood by reference to the following detailed description, appended claims, and accompanying figures, wherein elements are not to scale so as to more clearly show the details, wherein like reference numbers indicate like elements throughout the several views, and wherein:

FIG. 1 shows a plane view of an embodiment of a portable seat cushion from what would typically be referred to as the top of the seat cushion;

FIG. 2 shows a plane view of an embodiment of a portable seat cushion from what would typically be referred to as the bottom of the seat cushion;

FIG. 3 shows a first perspective view of an embodiment of a portable seat cushion;

FIG. 4 shows a second perspective view of an embodiment of a portable seat cushion;

FIG. 5 shows a first side view of an embodiment of a portable seat cushion;

FIG. 6 shows a first end view of an embodiment of a portable seat cushion;

FIG. 7 shows a second side view of an embodiment of a portable seat cushion;

FIG. 8 shows a second end view of an embodiment of a portable seat cushion;

FIG. 9 shows a cutaway view of an embodiment of a portable seat cushion cut along line A-A as shown in FIG. 2;

FIG. 10 shows a plane view of an embodiment of a portable seat cushion from what would typically be referred to as the top of the seat cushion;

FIG. 11 shows a somewhat schematic side view of a portable seat cushion;

FIG. 12 shows a perspective view of an embodiment of a portable seat cushion including an indentation along a top surface of the seat cushion;

FIGS. 13A, 13B, and 13C show examples of support pillars having equilateral polygonal block constant cross-sections;

FIG. 14 shows an example of a support pillar having an equilateral polygonal block dynamic cross-section;

FIG. 15 shows an example of a support pillar having a conical shape;

FIG. 16 shows an example of a support pillar having a rounded constant cross-section;

FIGS. 17A, 17B, and 17C show examples of support pillars having nonequilateral polygonal block constant cross-sections;

FIG. 18 shows an example of a support pillar having a nonequilateral polygonal block dynamic cross-section;

FIG. 19 shows examples of support pillars having cross-sections that represent a symbolic feature; and

FIG. 20 shows a somewhat schematic perspective view of an embodiment of a portable seat cushion including a pocket therein.

### DETAILED DESCRIPTION

Various terms used herein are intended to have particular meanings Some of these terms are defined below for the purpose of clarity. The definitions given below are meant to cover all forms of the words being defined (e.g., singular, plural, present tense, past tense). If the definition of any term below diverges from the commonly understood and/or dictionary definition of such term, the definitions below control.

Bench: any structure including a width ranging from about seven inches to about eighteen inches and a thickness ranging from about one-half inch to about three and one-half inches wherein a top surface of the structure is substantially planar.

Filler Material: talc, fiberglass, carbon fiber, wollastonite, MOS (Metal Oxy Sulfate), and other materials used as filler to make flexible polymeric material.

Flexible Polymeric Material: a mixture including a copolymer thermoplastic; thermoplastic polyalkenes, polyalkene elastomers, and/or mixtures thereof; and at least 1 wt. % filler material.

Pressure relief feature: a feature of some of the embodiments described herein that relieves pressure of the spinal column of a user of the portable seat cushion when such user sits in a traditional position along the portable seat cushion wherein the base of such user's spine is oriented adjacent the pressure relief feature.

Rounded Block: a three-dimensional shape having a cross-section that includes a curved edge at least partially forming the complete edge of the block.

Rubber: A highly elastic solid substance. Rubbers used for the purposes of this disclosure include, for example, EPR (ethylene-propylene rubber), EPDM (EP-diene rubber), EO (ethylene-octene), EB (ethylene-butadiene), SEBS (Styrene-ethylene-butadiene-styrene).

Symbolic Feature: a symbol or indicia indicating a source such as, for example, an athletic team logo.

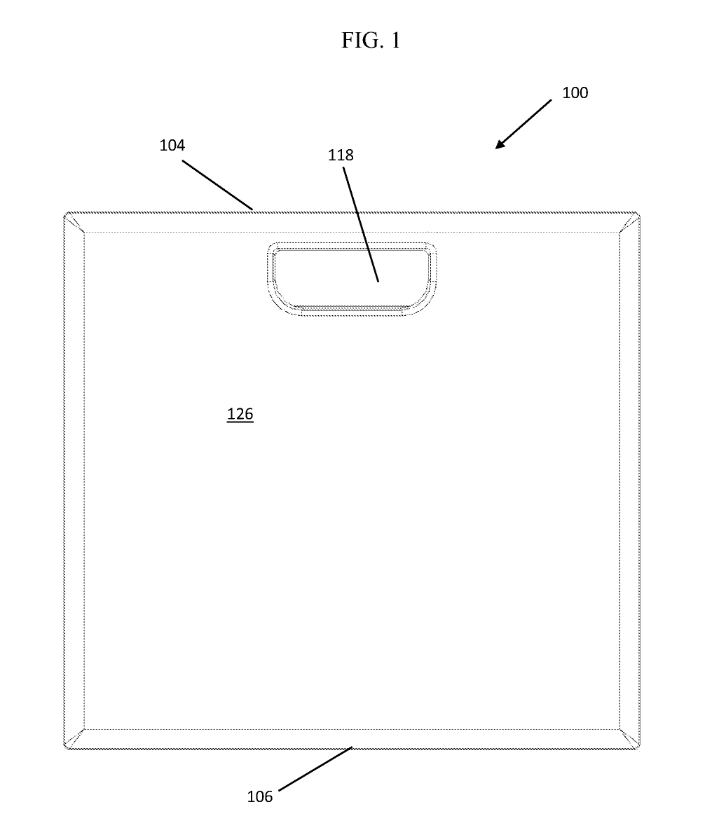

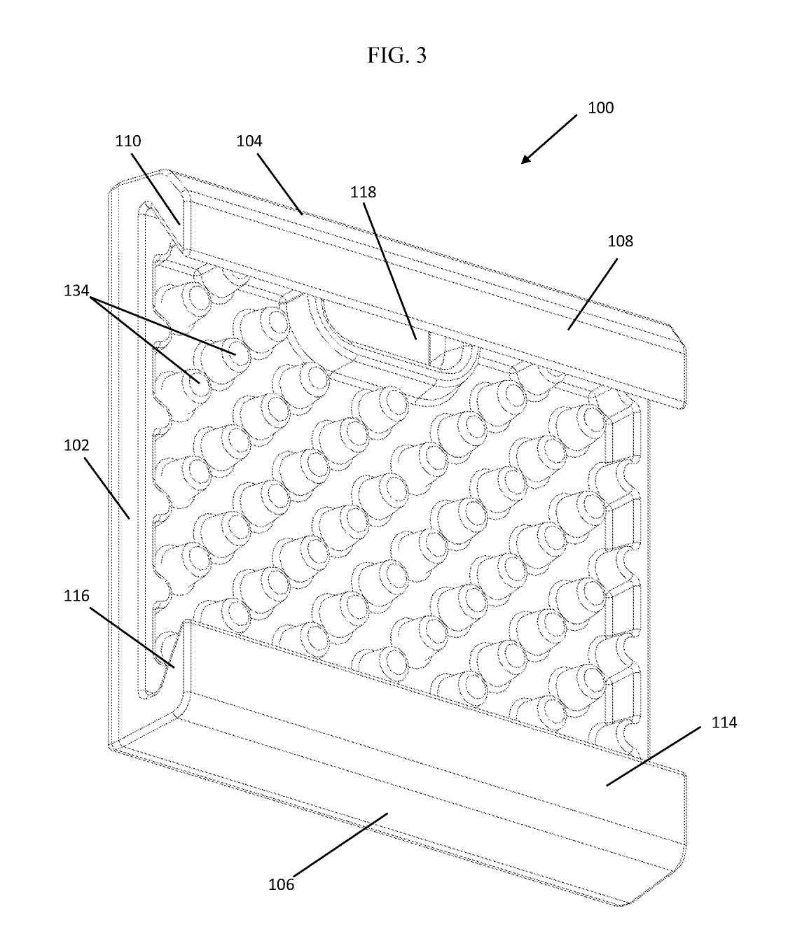

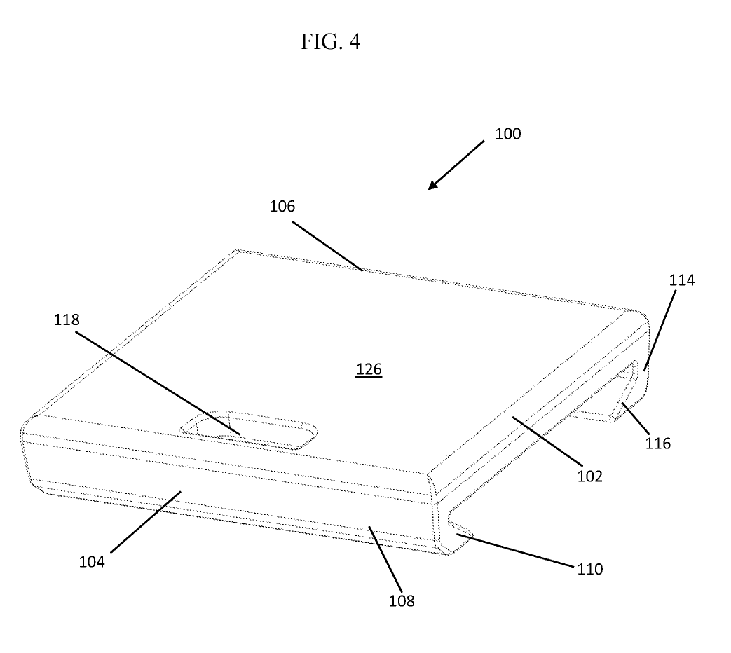

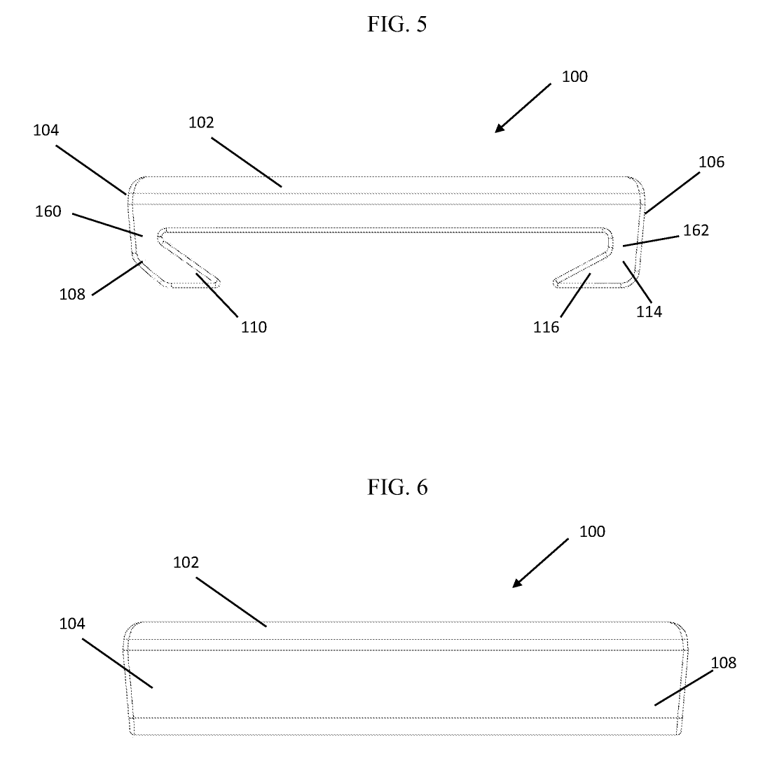

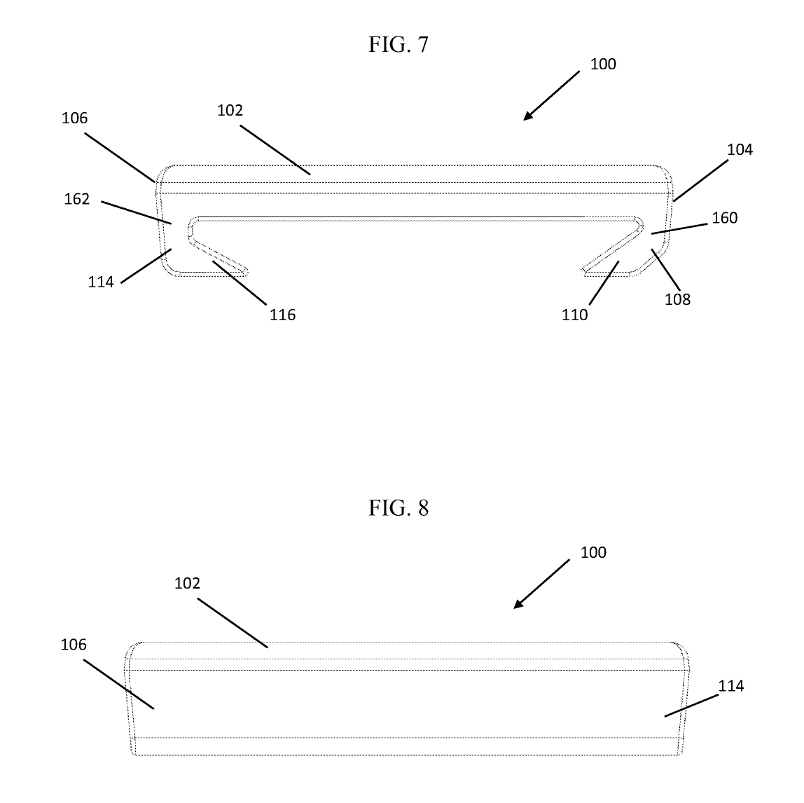

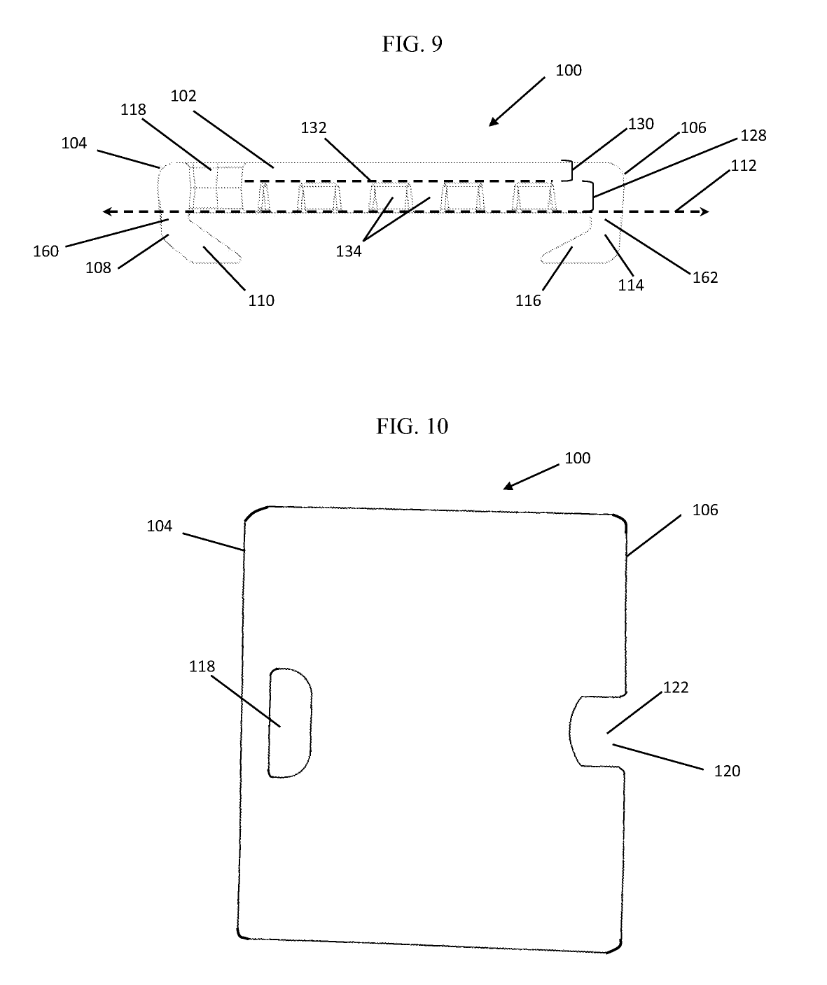

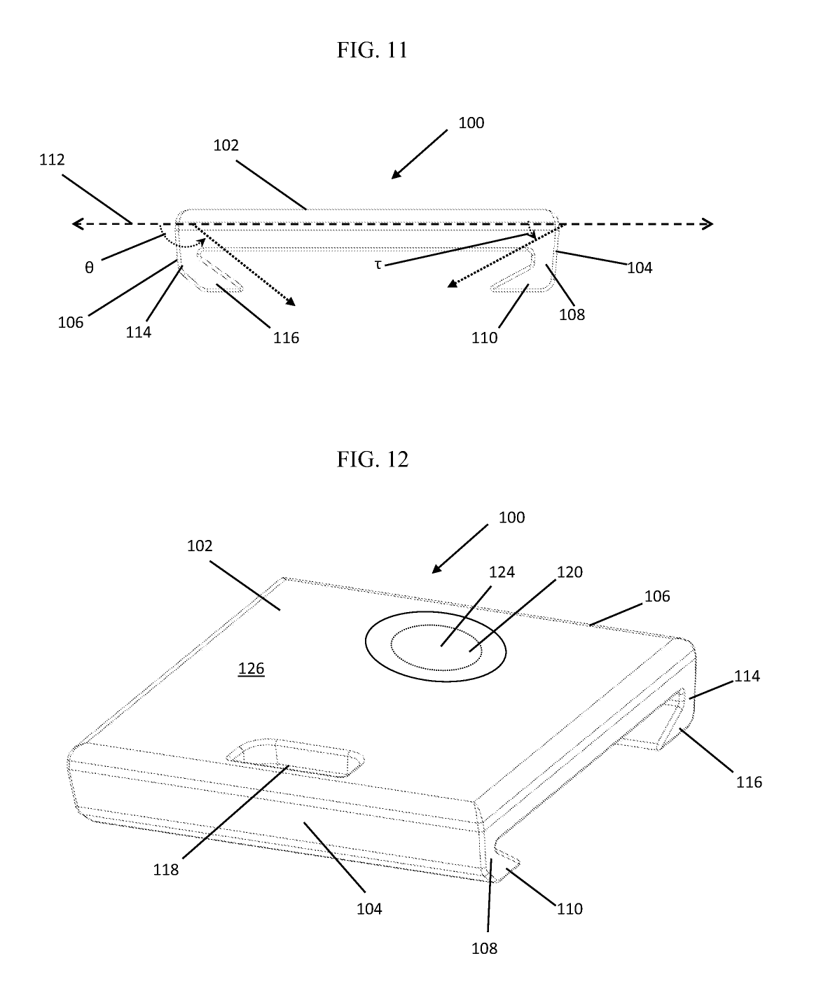

FIGS. 1-9 and FIG. 11 show different views of an embodiment of a portable seat cushion 100 including a seat portion 102 including a first end 104 and a second end 106. The seat cushion 100 further includes a first extension 108 located or otherwise attached adjacent the first end 104 of the seat portion 102, the first extension 108 further including a first angled portion 110 extending at an angle θ relative to an imaginary plane 112 defined at least from the first end 104 of the seat portion 102, proximate where the first extension 108 interfaces with the seat portion 102, to the second end 106 of the seat portion 102 proximate where a second extension 114 interfaces with the seat portion 102. The second extension 114 is located or otherwise attached adjacent the second end 106 of the seat portion 102 and includes a second angled portion 116 extending at an angle τ relative to the imaginary plane 112. The first angled portion 110 is flexible and resilient such that when the first angled portion 110 is moved in a direction away from the second angled portion 116, the first angled portion 110 becomes or otherwise remains biased to retain its original orientation relative to the imaginary plane 112.

The angle θ preferably ranges from about 105° to about 155° relative to the imaginary plane 112, and more preferably ranges from about 120° to about 140°. The angle τ preferably ranges from about 25° to about 75° relative to the imaginary plane 112, and more preferably from about 40° to about 60°. Although the first angled portion 110 is described in this particular embodiment as flexible and resilient, in other embodiments, the second angled portion 116 is similarly or alternatively flexible and resilient, allowing for the same important properties to be used.

In some embodiments, the second extension 114 can be thought of as a wedge that locks the rear portion (i.e., area adjacent the second end 106 of the seat portion 102) of the seat cushion 100 along a bench, and the first extension 108 can be thought of as a biased flap that holds the front portion (i.e., area adjacent the first end 104 of the seat portion 102) of the seat cushion 100 snug along such bench. Because the first angled portion 110 and the second angled portion 116 are preferably flexible, the seat cushion 100 can be locked into place along benches having various widths. The range of the difference in relative bench widths that the seat cushion 100 can be locked onto is typically from about one inch to about three inches. Because many benches vary in width and even thicknesses at various venues, the flexibility of the seat cushion described herein allows such seat cushion to be used at many different locations. The important feature of locking the seat cushion 100 in place prevents the seat cushion 100 from slipping or otherwise moving or shifting when a user stands up, sits down, or moves his/her body while seated on the seat cushion 100. In the various embodiments, no springs, clips, strings, or other such features are necessary to lock the seat cushion 100 in place along a bench. In addition to help lock the seat cushion 100 in place, the first extension 108 also acts as a pad and/or insulator to cushion or otherwise insulate a user's legs from a front edge of a bench.

In the embodiment shown in FIGS. 1-4 and 9, the seat cushion 100 further includes an aperture 118 through the seat portion 102 for use, for example, as a handle. In certain embodiments such as the embodiments shown in FIG. 10 and FIG. 12, the seat portion 102 includes a pressure relief feature 120 for relieving pressure along the spinal column of a user. In the embodiment shown in FIG. 10, the pressure relief feature 120 is in the form of a cutout portion 122 which is cut all the way through the seat portion 102. The specific example shown in FIG. 10 has the cutout portion 122 made along the second end 106 of the seat portion 102 and extending down along the second extension 114, thereby forming a void approximately centered along the second end 106 of the seat portion 102. In FIG. 12, the pressure relief feature is in the form of an indentation 124 cut into but not all the way through the seat portion 102. In the specific embodiment shown in FIG. 12, the indentation 124 is located along a first surface 126 of the seat portion 102 and centered along the second end 106 of the seat portion 102.

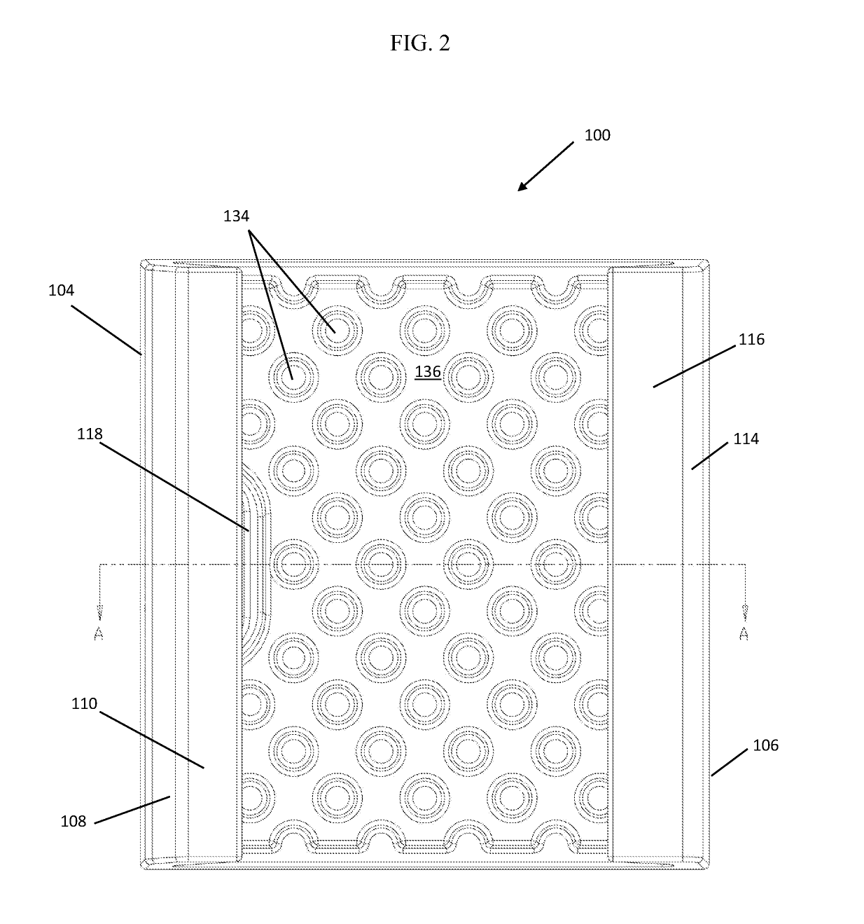

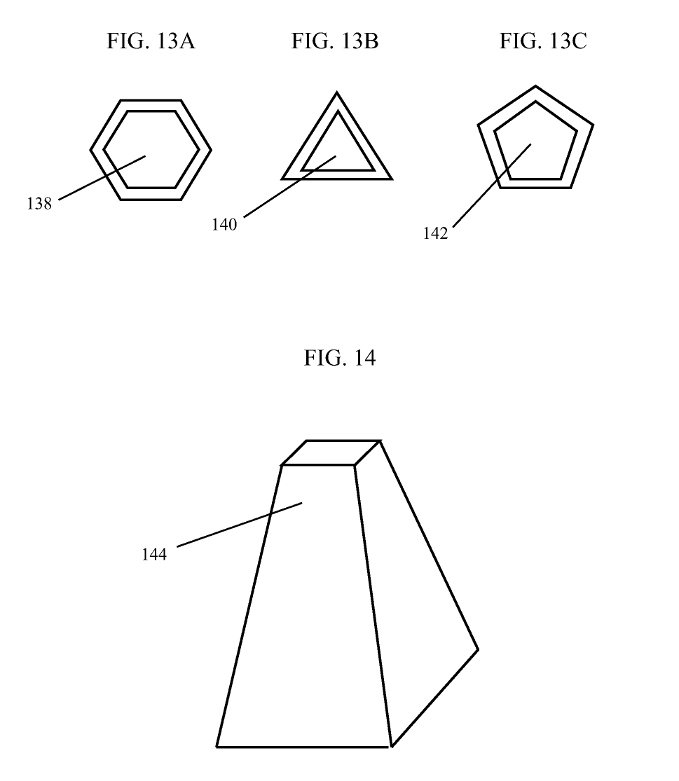

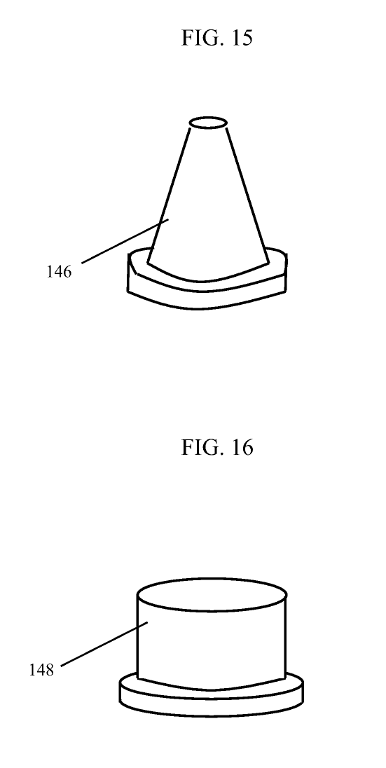

Preferably, as shown in FIGS. 2, 3, and 9, the seat portion 102 further includes a cavity portion 128 and a non-cavity portion 130, wherein the non-cavity portion 128 is defined depthwise from an interface 132 of the cavity portion 128 and the non-cavity portion 130 to the imaginary plane 112, and wherein the non-cavity portion 130 is defined depthwise from a first surface along the seat portion 102 to the interface 132. Preferably, a plurality of support pillars 134 extend from the interface 132 in an orientation substantially orthogonal to a second surface 136 along the seat portion 102. In various embodiments, the support pillars 134 can be the same size or different sizes, the same shape or different shapes, the same cross-sectional area or dynamic cross-sectional areas along the length of some or all the support pillars 134. The support pillars 134 can be separated in a regularly occurring pattern or a random pattern. Examples of support pillars having an equilateral polygonal cross-section and constant cross-sectional area are shown in FIGS. 13A (showing a support pillar 138 having an octagonal cross-section), 13B (showing a support pillar 140 having a triangular cross-section), and 13C (showing a support pillar 142 having a pentagonal cross-section). FIG. 14 shows an example of a support pillar 144 with a shape having an equilateral polygonal cross-section (i.e., square) wherein the area of the cross-section changes along the length of a support pillar having such a shape. FIG. 15 shows an exemplary shape of a support pillar 146 having a conical shape. FIG. 16 shows an example of a support pillar 148 including a constant rounded cross-sectional area.

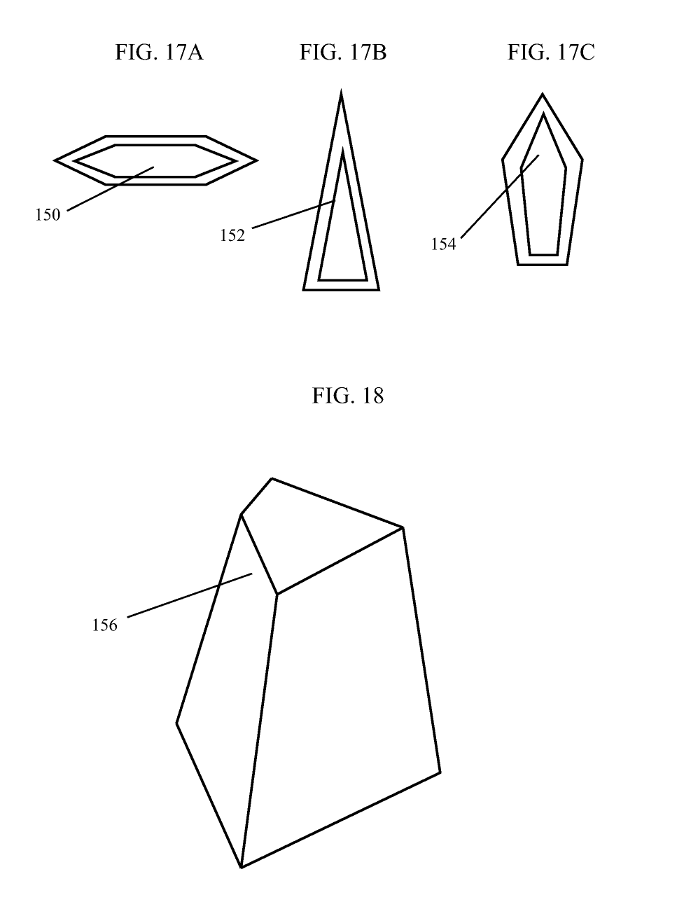

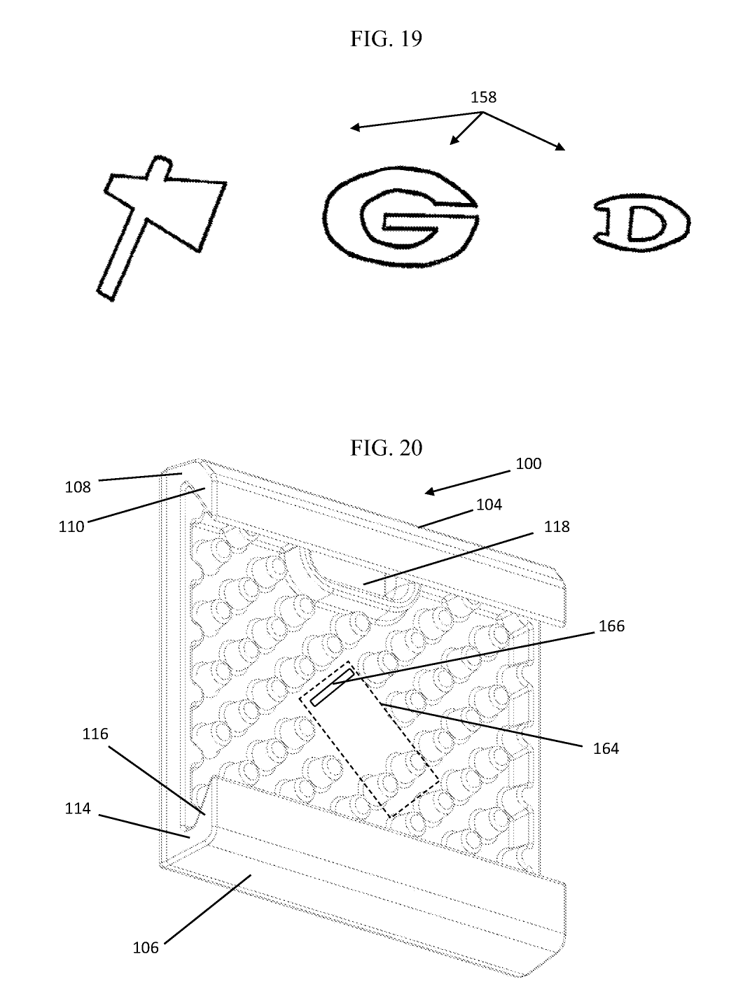

Examples of support pillars having a nonequilateral polygonal cross-section and constant cross-sectional area are shown in FIGS. 17A (showing a support pillar 150 having an octagonal cross-section), 17B (showing a support pillar 152 having a triangular cross-section), and 17C (showing a support pillar 154 having a pentagonal cross-section). FIG. 18 shows an example of a support pillar 156 with a shape having a four-sided nonequilateral polygonal cross-section wherein the area of the cross-section changes along the length of said support pillar. FIG. 19 shows examples of cross-sections for pillars 158 wherein the respective cross-sections are symbols that indicate, for example, a source or origin, an athletic team or franchise, a club, or other logo or emblem of an organization.

In the embodiments shown in FIGS. 5, 7, and 9, the first extension 108 further includes a first midsection 160 adjacent the first end 104 of the seat portion 102 and preferably situated between the seat portion 102 and the first angled portion 110. Similarly, the second extension 114 further includes a second midsection 162 adjacent the second end 106 of the seat portion 102 and preferably situated between the seat portion 102 and the second angled portion 116.

Preferably, the seat cushion 100 is manufactured as one piece. The seat cushion is preferably made of flexible polymeric material which preferably includes (1) a copolymer thermoplastic; (2) one or more thermoplastic alkenes, one or more polyalkene elastomers, and/or mixtures thereof; and (3) filler material. In certain embodiments, the seat cushion 100 includes a protective layer, preferably made of polymeric material. The protective layer may form automatically during manufacturing based on the material chosen to manufacture the seat cushion with. Alternatively, a manufactured seat cushion can have the protective layer applied to it directly by dipping, spraying, or other layer application technologies known to persons having ordinary skill in the art.

FIG. 20 shows an embodiment of the seat cushion 100 including a pocket 164 located within the seat portion 102. The pocket 164 is accessible via an access aperture 166. The pocket 164 can be used for many things including storing personal belongings (e.g., wallet, photo ID, admission ticket), a heat element (e.g., disposable hand warming packs), a cooling element (e.g., a frozen cooling pack), or other small item. Although the access aperture 166 shown in FIG. 20 is along the second surface 136 of the seat portion 102, other embodiments are contemplated wherein the access aperture is different sizes and at different locations on the seat portion. Similarly, various sizes and shapes for the pocket 164 are contemplated.

In a preferred embodiment, the seat cushion 100 has a length ranging from about ten inches to about eighteen inches, most preferably about fourteen inches; a width ranging from about twelve inches to about twenty inches, most preferably about sixteen inches; and a total thickness ranging from about two inches to about six inches, most preferably about four inches. Although specific ranges are listed, the dimensions for various embodiments may differ significantly. For example, one embodiment may have a width of from about forty inches to about fifty inches to accommodate two users to sit on the portable seat cushion simultaneously. A preferred embodiment of the seat cushion 100 is manufactured as one piece of cross-linked ethyl vinyl acetate closed cell foam made using injection molding technology, compression molding technology and/or custom cut with equipment such as, for example, a high pressure water jet and/or computer numerical control (CNC) based machine.

In addition to the apparatus embodiments described herein, the disclosure further includes embodiments of methods for manufacturing a disposable seat cushion having some or all of the characteristics described herein. In a first embodiment, a method for manufacturing a portable seat cushion includes the steps of (a) adding a polymeric mixture to a mold and (b) applying heat to the polymeric mixture to cure the mixture in the form of the mold, wherein the cured product includes a one or more embodiments of the seat portion 100 described herein. Step (a) preferably further includes the substep (a)(i) of preheating the polymeric mixture; and the substep of (a)(ii) injecting the preheated polymer mixture into the mold or (a)(ii)′ compressing a plurality of mold plates together, wherein the plurality of mold plates form the entirety of the mold. In a related embodiment, the method further includes the steps of (c) cutting an aperture through the seat portion to form a carrying handle; (d) optionally adding a pressure relief feature to the seat portion wherein the pressure relief feature includes (i) a cutout portion along the second end of the seat portion, extending along the second extension which provides a void approximately centered along the second end of the seat portion or (ii) an indentation along a top surface of the seat portion approximately centered along the second end of the seat portion; and (e) optionally coating the portable seat cushion with a protective polymer layer.

The foregoing description of preferred embodiments of the present disclosure has been presented for purposes of illustration and description. The described preferred embodiments are not intended to be exhaustive or to limit the scope of the disclosure to the precise form(s) disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the concepts revealed in the disclosure in various embodiments and with various modifications as are suited to the particular use contemplated. All such modifications and variations are within the scope of the disclosure as determined by the appended claims when interpreted in accordance with the breadth to which they are fairly, legally, and equitably entitled.

Any element in a claim that does not explicitly state “means for” performing a specified function, or “step for” performing a specific function, is not to be interpreted as a “means” or “step” clause as specified in 35 U.S.C. §112, ¶6. In particular, the use of “step of” in the claims herein is not intended to invoke the provisions of 35 U.S.C. §112, ¶6.

What is claimed is:

1. A portable seat cushion comprising a seat portion including a first end and a second end; a first extension adjacent the first end of the seat portion, the first extension including a first angled portion extending at an angle ranging from about 105° to about 155° relative to an imaginary plane extending from the first end of the seat portion proximate where the first extension interfaces with the seat portion to the second end of the seat portion proximate where a second extension interfaces with the seat portion; the second extension adjacent the second end of the seat portion including a second angled portion extending at an angle ranging from about 25° to about 75° relative to the imaginary plane, wherein the first angled portion, when moved away from the second extension, is biased toward the second extension to provide a snug fit between the seat cushion and a bench, and wherein the first angled portion is flexible to a degree that the seat cushion can be removably attached to benches that vary in width up to from about 2 inches to about 4 inches.

2. The portable seat cushion of claim 1 wherein the seat cushion is manufactured as a single piece of flexible polymeric material.

3. The portable seat cushion of claim 1 wherein the first angled portion extends at an angle ranging from about 120° to about 140° relative to the imaginary plane, and wherein the second angled portion extends at an angle ranging from about 40° to about 60° relative to the imaginary plane.

4. The portable seat cushion of claim 1 further comprising an aperture through the seat portion adjacent the first end of the seat portion to form a handle for carrying the portable seat cushion.

5. The portable seat cushion of claim 1 further comprising a pressure relief feature along the seat portion adjacent the second end proximate where a user's tailbone typically would be located when sitting on the seat cushion.

6. The portable seat cushion of claim 5 wherein the pressure relief feature comprises a feature selected from the group consisting of a cutout portion along the second end of the seat portion, extending along the second extension which provides a void approximately centered along the second end of the seat portion; and an indentation along a top surface of the seat portion approximately centered along the second end of the seat portion.

7. The portable seat cushion of claim 1 wherein the seat portion further comprises a cavity portion and non-cavity portion, wherein the cavity portion includes a cavity defined depthwise from the imaginary plane to the non-cavity portion; and a plurality of support pillars extending from the non-cavity portion to the imaginary plane.

8. The portable seat cushion of claim 7 wherein the support pillars are of substantially equal size.

9. The portable seat cushion of claim 7 wherein the support pillars are spaced apart substantially equally in a substantially symmetrical pattern.

10. The portable seat cushion of claim 7 wherein at least some of the support pillars comprise a shape selected from the group consisting of an equilateral polygonal block having a constant cross sectional area, an equilateral polygonal block having a diminishing cross sectional area as the length of the block extends to the imaginary plane from the non-cavity portion, a cone having a diminishing cross-sectional area as the length of the block extends to the imaginary plane from the non-cavity portion, and a rounded block having a constant cross sectional area.

11. The portable seat cushion of claim 7 wherein at least some of the support pillars comprise a shape selected from the group consisting of a non-equilateral polygonal block having a constant cross sectional area, and a non-equilateral polygonal block having a diminishing cross sectional area as the length of the block extends to the imaginary plane from the non-cavity portion.

12. The portable seat cushion of claim 7 wherein at least one of the support pillars comprises a cross-section in the shape of a symbolic feature.

13. The portable seat cushion of claim 1 wherein the first extension further comprises a first midsection adjacent the first end of the seat portion and situated between the seat portion and the first angled portion; and wherein the second extension further comprises a second midsection adjacent the second end of the seat portion and situated between the seat portion and the second angled portion.

14. The portable seat cushion of claim 2 wherein the flexible polymeric material comprises a mixture comprising a copolymer thermoplastic; a substance selected from the group consisting of thermoplastic polyalkenes, polyalkene elastomers, and mixtures thereof; and filler material.

15. The portable seat cushion of claim 14 further comprising an outer protective polymer layer.

16. The portable seat cushion of claim 1 further comprising a pocket located within the seat portion and an access aperture located along an outer surface of the seat portion wherein a heating element can be inserted through the access aperture and into the pocket to warm the portable seat cushion.

17. A method for manufacturing a portable seat cushion, the method comprising the steps of:
(a) adding a polymeric mixture to a mold; and
(b) applying heat to the polymeric mixture to cure the mixture in the form of the mold,
wherein the cured product comprises a seat portion including a first end and a second end; a first extension adjacent the first end of the seat portion, the first extension including a first angled portion extending at an angle ranging from about 285° to about 335° relative to an imaginary plane extending from the first end of the seat portion proximate where the first extension interfaces with the seat portion to the second end of the seat portion proximate where a second extension interfaces with the seat portion; the second extension adjacent the second end of the seat portion including a second angled portion extending at an angle ranging from about 205° to about 255° relative to the imaginary plane, wherein the first extension is biased toward the second extension to provide a snug fit between the seat cushion and a bench, and wherein the first angled portion, when moved away from the second extension, is biased toward the second extension to provide a snug fit between the seat cushion can be removably attached to benches that vary in width up to from about 2 inches to about 4 inches.

18. The method of claim 17 wherein step (a) further comprises the steps of (a)(i) preheating the polymeric mixture and the steps selected from the group consisting of (a)(ii) injecting the preheated polymer mixture into the mold, and (a)(ii)′ compressing a plurality of mold plates together.

19. The method of claim 18 further comprising the step of (c) cutting an aperture through the seat portion to form a carrying handle.

20. The method of claim 18 further comprising the steps of:
(c)′ adding a pressure relief feature to the seat portion wherein the pressure relief feature comprises a feature selected from the group consisting of a cutout portion along the second end of the seat portion, extending along the second extension which provides a void approximately centered along the second end of the seat portion; and an indentation along a top surface of the seat portion approximately centered along the second end of the seat portion; and
(d) optionally coating the portable seat cushion with a protective polymer layer.
